(19) United States
(12) Patent Application Publication
(10) Pub. No.: US 2026/0332350 A1
(43) Pub. Date: Oct. 22, 2026

(54) PREAMBLE MAPPING TO ORTHOGONAL COVER CODES

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(73) Assignee: Lenovo (United States) Inc., Morrisville, NC (US)

(21) Appl. No.: 19/300,521

(22) Filed: Aug. 14, 2025

(51) Int. Cl. H04L 5/00; H04L 1/08; H04W 74/0833

(52) U.S. Cl. CPC H04L 5/0053; H04L 1/08; H04L 5/0016; H04W 74/0833

(57) ABSTRACT

Various aspects of the present disclosure relate to preamble mapping to orthogonal cover codes (OCCs). An apparatus, such as a user equipment (UE), receives configuration information that indicates a mapping of a preamble space of a random access channel (RACH), which includes one or more preambles, and one or more corresponding RACH occasions (ROs) with a set of multiple physical uplink shared channel (PUSCH) occasions and a set of multiple OCCs. Based on the mapping, the UE determines one or more PUSCH occasions from the set of PUSCH occasions and an OCC from the set of OCCs. The OCC corresponds to an OCC sequence index and an OCC sequence length. The UE transmits a set of multiple PUSCH repetitions in the one or more PUSCH occasions, where the PUSCH repetitions are multiplexed in a time-frequency resource based on the OCC.

### TECHNICAL FIELD

The present disclosure relates to wireless communications, and more specifically to preamble mapping to orthogonal cover codes (OCCs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive configuration information that indicates a mapping of a preamble space of a random access channel (RACH) and one or more corresponding RACH occasions (ROs) with a set of multiple physical uplink shared channel (PUSCH) occasions and a set of multiple OCCs; determine, based on the mapping, one or more PUSCH occasions from the set of multiple PUSCH occasions and an OCC from the set of multiple OCCs; and transmit a set of multiple PUSCH repetitions in the one or more PUSCH occasions, where the set of multiple PUSCH repetitions are multiplexed in a time-frequency resource based on the OCC.

A processor (e.g., a standalone processor chipset, or a component of a UE) for wireless communication is described. The processor may be configured to, capable of, or operable to perform one or more operations as described herein. For example, the processor may be configured to, capable of, or operable to receive configuration information that indicates a mapping of a preamble space of a RACH and one or more corresponding ROs with a set of multiple PUSCH occasions and a set of multiple OCCs; determine, based on the mapping, one or more PUSCH occasions from the set of multiple PUSCH occasions and an OCC from the set of multiple OCCs; and transmit a set of multiple PUSCH repetitions in the one or more PUSCH occasions, where the set of multiple PUSCH repetitions are multiplexed in a time-frequency resource based on the OCC.

A method performed or performable by a UE for wireless communication is described. The method may include receiving configuration information that indicates a mapping of a preamble space of a RACH and one or more corresponding ROs with a set of multiple PUSCH occasions and a set of multiple OCCs; determining, based on the mapping, one or more PUSCH occasions from the set of multiple PUSCH occasions and an OCC from the set of multiple OCCs; and transmitting a set of multiple PUSCH repetitions in the one or more PUSCH occasions, where the set of multiple PUSCH repetitions are multiplexed in a time-frequency resource based on the OCC.

In some implementations of the UE, the processor, and the method described herein, to determine the OCC, the UE, the processor, and the method may further be configured to, capable of, operable to, performed to, or performable to determine at least an OCC sequence index or an OCC sequence length corresponding to the OCC. In some implementations of the UE, the processor, and the method described herein, the configuration information indicates a maximum number of preambles in the preamble space. In some implementations of the UE, the processor, and the method described herein, the preamble space includes one or more preambles associated with respective preamble identifiers (IDs), and where the respective preamble IDs are mapped to corresponding OCC IDs associated with the set of multiple OCCs.

In some implementations of the UE, the processor, and the method described herein, the set of multiple PUSCH repetitions are multiplexed based on a slot repetition mapping type. In some implementations of the UE, the processor, and the method described herein, the slot repetition mapping type is a time domain OCC (TD-OCC) slot repetition mapping type or a frequency domain (FD-OCC) slot repetition mapping type, where the TD-OCC slot repetition mapping type is based on inter-slot repetitions and an OCC sequence length and the FD-OCC slot repetition mapping type is based on intra-slot repetitions and an OCC sequence length.

In some implementations of the UE, the processor, and the method described herein, the configuration information indicates a mapping between a set of multiple OCC sequence lengths and the set of multiple PUSCH occasions for a number of PUSCH repetitions. In some implementations of the UE, the processor, and the method described herein, the configuration information indicates a mapping between the preamble space, a slot repetition mapping type, and a number of the set of multiple PUSCH repetitions multiplexed in a number of the set of multiple PUSCH occasions.

In some implementations of the UE, the processor, and the method described herein, the configuration information indicates a set of multiple PUSCH repetitions mapped to the preamble space based on a reference signal received power (RSRP) threshold, and where the at least one processor is further operable to cause the UE to select a preamble from the preamble space based on a compare of an RSRP of a received signal to the RSRP threshold.

An NE (e.g., a base station) for wireless communication is described. The NE may be configured to, capable of, or operable to perform one or more operations as described herein. For example, the NE may be configured to, capable of, or operable to transmit configuration information that indicates a mapping of a preamble space of a RACH and one or more corresponding ROs with a set of multiple PUSCH occasions and a set of multiple OCCs; and receive a set of multiple PUSCH repetitions in one or more PUSCH occasions, where the set of multiple PUSCH repetitions are multiplexed in a time-frequency resource based on an OCC of the set of multiple OCCs.

A processor (e.g., a standalone processor chipset, or a component of a NE) for wireless communication is described. The processor may be configured to, capable of, or operable to perform one or more operations as described herein. For example, the processor may be configured to, capable of, or operable to transmit configuration information that indicates a mapping of a preamble space of a RACH and one or more corresponding ROs with a set of multiple PUSCH occasions and a set of multiple OCCs; and receive a set of multiple PUSCH repetitions in one or more PUSCH occasions, where the set of multiple PUSCH repetitions are multiplexed in a time-frequency resource based on an OCC of the set of multiple OCCs.

A method performed or performable by an NE (e.g., a base station) for wireless communication is described. The method may include transmitting configuration information that indicates a mapping of a preamble space of a RACH and one or more corresponding ROs with a set of multiple PUSCH occasions and a set of multiple OCCs; and receiving a set of multiple PUSCH repetitions in one or more PUSCH occasions, where the set of multiple PUSCH repetitions are multiplexed in a time-frequency resource based on an OCC of the set of multiple OCCs.

In some implementations of the NE, the processor, and the method described herein, the OCC corresponds to an OCC sequence index and an OCC sequence length. In some implementations of the NE, the processor, and the method described herein, the configuration information indicates a maximum number of preambles in the preamble space. In some implementations of the NE, the processor, and the method described herein, the preamble space includes one or more preambles associated with respective preamble IDs, and where the respective preamble IDs are mapped to corresponding OCC IDs associated with the set of multiple OCCs.

In some implementations of the NE, the processor, and the method described herein, the set of multiple PUSCH repetitions are multiplexed based on a slot repetition mapping type. In some implementations of the NE, the processor, and the method described herein, the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length.

In some implementations of the NE, the processor, and the method described herein, the configuration information indicates a mapping between a set of multiple OCC sequence lengths and the set of multiple PUSCH occasions for a number of PUSCH repetitions. In some implementations of the NE, the processor, and the method described herein, the configuration information indicates a mapping between the preamble space, a slot repetition mapping type, and a number of the set of multiple PUSCH repetitions multiplexed in a number of the set of multiple PUSCH occasions. In some implementations of the NE, the processor, and the method described herein, the configuration information indicates a set of multiple PUSCH repetitions mapped to the preamble space based on an RSRP threshold.

### BRIEF DESCRIPTION OF THE DRAWINGS

FIG. 1 illustrates an example of a wireless communications system in accordance with aspects of the present disclosure.

FIG. 2 illustrates an example of a mapping between a preamble resource occasion, OCC indices, and repetition mapping type, in accordance with aspects of the present disclosure.

FIG. 3 illustrates an example of a TD-OCC sequence, in accordance with aspects of the present disclosure.

FIG. 4 illustrates an example of an FD-OCC sequence, in accordance with aspects of the present disclosure.

FIG. 5 illustrates an example of a mapping between a preamble resource occasion, PUSCH repetitions, and mapping type, in accordance with aspects of the present disclosure.

FIG. 6 illustrates an example of a mapping between synchronization signal block (SSB), ROs, and OCC-PUSCH in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some cases, the UE may transmit multiple PUSCH repetitions using separate time-frequency resources to improve reliability and enable diversity gain. To facilitate multiplexing of multiple UEs or logical channels within a same time-frequency resource, OCCs may be applied to repeated PUSCH transmissions, thus reducing inter-user interference and recover spectral efficiency. Additionally, a 2-step RACH procedure may be associated with a Message A (MsgA) PUSCH occasion corresponding to one or more ROs. Coverage enhancement schemes such as preamble repetition may utilize the same preamble between repetitions. The wireless communications system may be further improved by utilizing OCCs to recover the spectral efficiency and repetitions to improve coverage.

Aspects of the present disclosure are described in the context of a wireless communications system, and include implementations that provide for the association of preambles to OCCs for PUSCH transmissions. In some cases, orthogonal multiplexing of one or more Message 3 (Msg3) transmissions, repeatedly transmitted by one or more UEs in one or more PUSCH occasions using OCC sequences, may save resource overhead compared to transmission of repetitions without OCCs. As such, the described techniques support the usage of a preamble space or a combination of a preamble space and preamble resource occasions to convey a number of PUSCH repetitions using one or more OCCs to meet uplink coverage. In some examples, the NE may configure a mapping (e.g., association, correspondence) between the preamble space and/or preamble resource occasions to a number of corresponding PUSCH occasions, where each PUSCH occasion, due to an OCC sequence length of N, may support N PUSCH transmissions with repetitions. Additionally, the NE may configure a mapping between the preamble space to a repetition mapping type using OCCs such as inter-slot or intra-slot repetitions using TD-OCC, FD-OCC, or a combination thereof. Any of the mappings described herein may be associated with a preamble or a set or subset of preambles (e.g., of a preamble space).

Specifically, a UE may receive configuration information that indicates a mapping (e.g., association, correspondence) of a preamble space of a RACH, which includes one or more preambles, and one or more corresponding ROs with a set of multiple PUSCH occasions and a set of multiple OCCs. Based on the mapping, the UE may determine one or more PUSCH occasions from the set of PUSCH occasions and an OCC from the set of OCCs. The OCC may correspond to an OCC sequence index and an OCC sequence length. The UE may transmit PUSCH repetitions in the one or more PUSCH occasions, where the PUSCH repetitions are multiplexed in a time-frequency resource based on the OCC. By performing the described techniques, a device in a wireless communications system can recover spectral efficiency, reduce overhead, and improve coverage.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

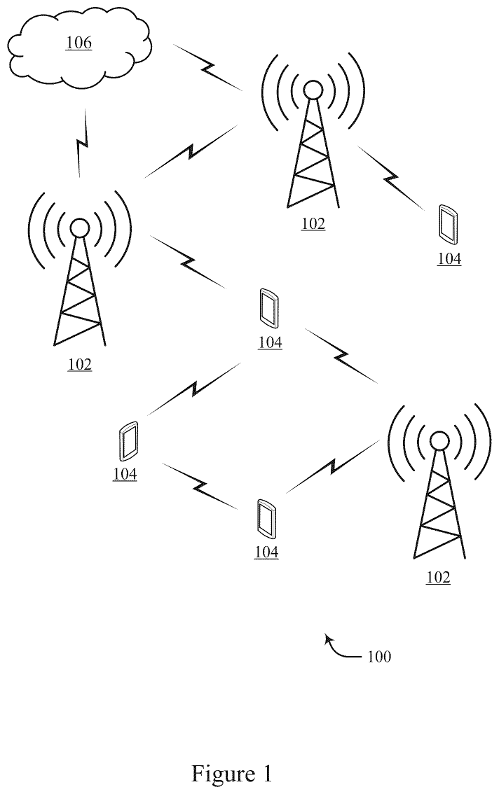

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities. FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives configuration information that indicates a mapping (e.g., association, correspondence) of a preamble space of a RACH, which includes one or more preambles, and one or more corresponding ROs with a set of multiple PUSCH occasions and a set of multiple OCCs. Based on the mapping, the UE 104 determines one or more PUSCH occasions from the set of PUSCH occasions and an OCC from the set of OCCs. The OCC may correspond to an OCC sequence index and an OCC sequence length. The UE 104 transmits PUSCH repetitions in the one or more PUSCH occasions, where the PUSCH repetitions are multiplexed in a time-frequency resource based on the OCC.

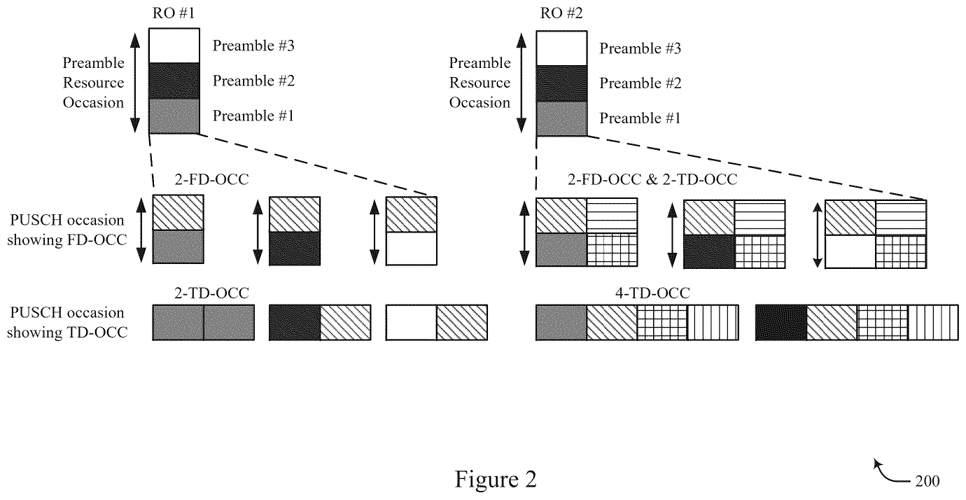

FIG. 2 illustrates an example of a mapping 200 in accordance with aspects of the present disclosure. The mapping 200 is between a preamble resource occasion, OCC indices, and repetition mapping types. The mapping 200 may be implemented or supported by UEs and NEs in a wireless communications system, such as the UEs 104 and the NEs 102 of FIG. 1.

As described herein, each PUCH transmitted in an uplink resource occasion may be associated with a preamble transmitted in a preamble resource occasion or a preamble space. In the example of FIG. 2, RO #1 may be associated with a preamble resource occasion, including a preamble #1, a preamble #2, and a preamble #3. Additionally, RO #2 may be associated with a preamble resource occasion, including a preamble #1, a preamble #2, and a preamble #3. An NE may configure a maximum number of preambles in a preamble resource occasion, and each preamble resource occasion may be associated with a number N PUSCH occasions.

Each preamble may be associated with an OCC sequence (e.g., a sequence length or an index to a table indicating a set of multiple sequences) that is used to multiplex PUSCHs from multiple UEs in the respective RO (e.g., uplink resource occasion). The OCC sequences may include a family of Hadamard binary cover codes used to orthogonalize sequences. Additionally, or alternatively, an OCC sequence may be a discrete Fourier transform (DFT)-based sequence. In some examples, the NE may configure a maximum number of preambles in a preamble resource occasion, and each preamble (with an associated preamble ID) in the preamble resource occasion may be associated with (e.g., mapped to) a corresponding separate PUSCH occasion. Each PUSCH occasion of a set of PUSCH occasions mapped to the preamble resource occasion may be configured to transmit N repetitions. That is, N PUSCH repetitions may depend on an OCC sequence length of N. In this way, each preamble or set of preambles in a preamble resource occasion may be associated with or mapped to a corresponding PUSCH occasion with N repetitions.

In some examples, each preamble in a preamble resource occasion may have a corresponding preamble ID and each OCC may have a corresponding OCC ID. In such cases, the NE may map each preamble ID to one or more corresponding OCC IDs that may be used in one or more PUSCH occasions for multiplexing PUSCH repetitions. Additionally, or alternatively, a set of preambles may be associated with an OCC ID that may be used in one or more PUSCH occasions. For example, a first UE (i.e., UE #1) and a second UE (i.e., UE #2) may use preamble #1 and preamble #2, respectively, which are associated with a same PUSCH occasion and a same OCC sequence length, however, with different OCC sequence IDs or indices. This may enable PUSCH transmissions from two UEs using two different orthogonal sequences.

Additionally, or alternatively, there may be M preamble resource occasions for preamble transmissions associated with (i.e., mapped to) N PUSCH occasions configured for transmission with an OCC. The UE may select a preamble and repeatedly transmit the selected preamble in each of the M occasions such that proper coverage may be dimensioned for both the preamble and associated PUSCH transmissions. The mapping between the preamble, the OCC sequence, and the PUSCH occasion may be kept the same for each PUSCH repetition. In one implementation, each preamble may be associated with (i.e., mapped to) a configured grant (CG) index or CG period including one or more timing occasions. Additionally, preamble IDs (e.g., RACH preamble indices) may be mapped to CG indices or CG periods in an ascending order. In some other implementations, each RO may be associated with (i.e., mapped to) a CG period including one or more timing occasions, where the ROs may be mapped to the CG periods in an ascending order. In some cases, a combination of mapping between CG indices, CG periods, preamble IDs, and ROs may be configured and supported.

When a UE selects a preamble from a preamble resource occasion for transmission, then a corresponding (i.e., mapped) OCI ID may be used for a number of PUSCH transmissions in a number of PUSCH occasions. In the example of FIG. 2, preamble #1 corresponding to RO #1 may be mapped to a PUSCH occasion that is configured to multiplex two UEs using two PUSCH repetitions based on a slot repetition mapping type, such as 2-TD-OCC or 2-FD-OCC. In such cases, a slot mapping type for the transmission of the 2-TD-OCC PUSCH repetitions may be based on inter-slot repetitions using OCC sequences, while the 2-FD-OCC PUSCH repetitions may be based on intra-slot repetitions using OCC sequences. Preamble #2 and preamble #3 may also each be mapped to a PUSCH occasion configured to multiplex two UEs using two PUSCH repetitions based on a TD-OCC or FD-OCC slot repetition mapping type. Additionally, or alternatively, the NE may configure the RO #2 for multiplexing two UEs using four PUSCH repetitions using a 2-FD-OCC and 2-TD-OCC slot repetition mapping type or a 4-TD-OCC slot repetition mapping type. For example, preamble #1 and preamble #2 may each be mapped to PUSCH occasions configured to multiplex two UEs using the four PUSCH repetitions using the 2-FD-OCC and 2-TD-OCC slot repetition mapping type or the 4-TD-OCC slot repetition mapping type, and preamble #3 in the example of the mapping 200 may be mapped to a PUSCH occasion configured to multiplex the two UEs using four PUSCH repetitions and a 2-TD-FD-OCC and 2-FD-OCC slot repetition mapping type. In this way, each preamble resource occasion may be configured with a fixed OCC sequence length and therefore, a fixed number of PUSCH repetitions. The UE may select a preamble resource occasion based on a number of PUSCH repetitions needed to achieve a particular PUSCH coverage target.

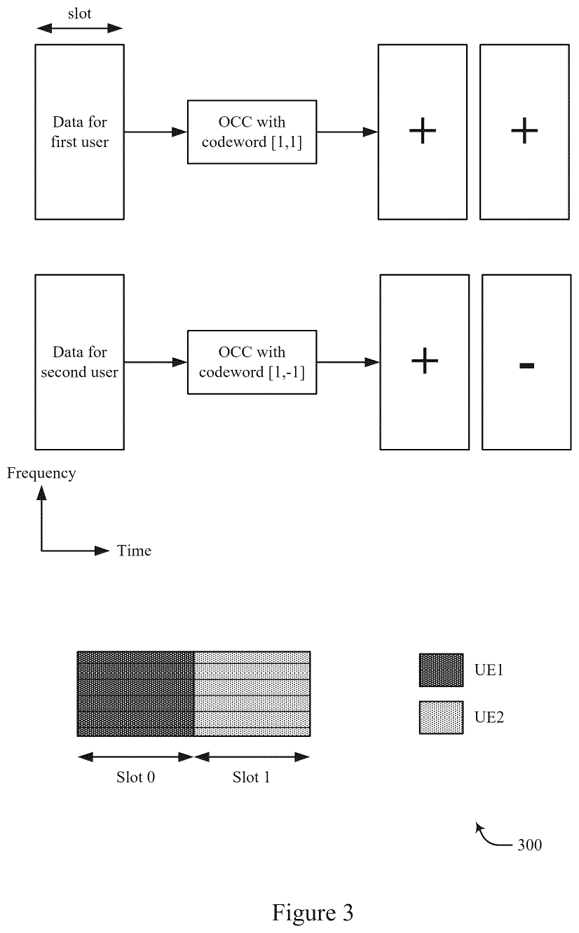

FIG. 3 illustrates an example of a TD-OCC sequence 300 in accordance with aspects of the present disclosure. In this example, the TD-OCC sequence 300 may have a length of two and may be applied to two PUSCH repetitions in a PUSCH occasion.

As described with reference to FIG. 2, one or more OCCs may be mapped to a preamble and indicated using corresponding OCC IDs, also referred to herein as OCC indices. Each OCC ID may correspond to various OCC sequences, and the NE may configure an OCC sequence length or one or more OCC IDs to be used in a number of PUSCH occasions for a number of PUSCH repetitions. For example, Table 1 indicates four orthogonal sequences with a length of four, which may be used for four PUSCH repetitions, and Table 2 indicates two orthogonal sequences with a length of 2, which may be used for two PUSCH repetitions. In some examples, it may be possible to use two orthogonal sequences with a length of four for two PUSCH repetitions.

TABLE 1
4-OCC Sequences

| OCC sequence index | OCC Sequence |
|---|---|
| 0 | [+1, +1, +1, +1] |
| 1 | [+1, −1, +1, −1] |
| 2 | [+1, +1, −1, −1] |
| 3 | [+1, −1, −1, +1] |

TABLE 2
2-OCC Sequences

| OCC sequence index | OCC Sequence |
|---|---|
| 0 | [+1, +1] |
| 1 | [+1, −1] |

The TD-OCC sequence 300 may be an example of a 2-OCC sequence of Table 2. For example, an OCC with a codeword [1, 1] may be applied to data for a first user (i.e., UE1). That is, according to Table 2, an OCC sequence index 0 with an OCC sequence [+1, +1] may be applied to the data for the first user. Additionally, an OCC with a codeword [1, −1] may be applied to data for a second user (i.e., UE2). That is, according to Table 2, an OCC sequence index 1 with an OCC sequence [+1, −1] may be applied to the data for the second user. Based on applying such OCC sequences, the data for the first and second users may be multiplexed and transmitted (i.e., repeated) in both slot 0 (e.g., +, + sequence) and a slot 1 (e.g., +, − sequence).

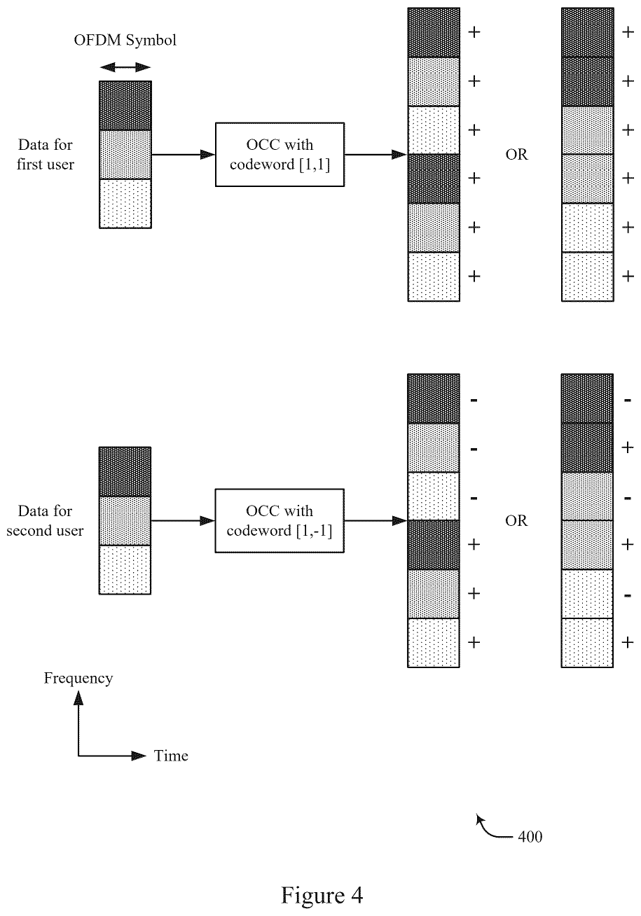

FIG. 4 illustrates an example of an FD-OCC sequence 400 in accordance with aspects of the present disclosure. In this example, the FD-OCC sequence 400 may be used to transmit data for both a first user (i.e., UE1) and a second user (i.e., UE2). The respective data may span one OFDM symbol. An OCC with a codeword [1, 1] may be applied to the data for the first user and an OCC with a codeword [1, −1] may be applied to the data for the second user. In this way, the data for the two users may be multiplexed such that the data for the first user has a sequence of +, +, +, +, +, + and the data for the second user has a sequence of −, −, −, +, +, +, or the data may be multiplexed such that the data for the first user has a sequence of +, +, +, +, +, + and the data for the second user has a sequence of −, +, −, +, −, +.

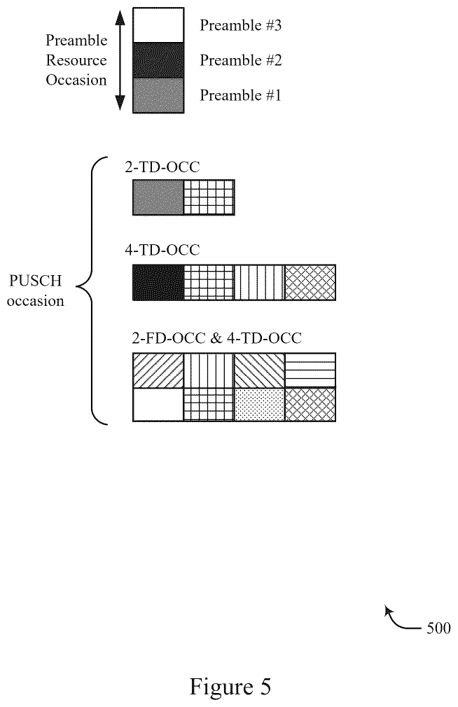

FIG. 5 illustrates an example of a mapping 500 in accordance with aspects of the present disclosure. In this example, the mapping 500 is between a preamble resource occasion, PUSCH repetitions, and mapping type. The mapping 500 may be implemented or supported by UEs and NEs in a wireless communications system, such as the UEs 104 and the NEs 102 of FIG. 1.

In some implementations, the NE may configure the mapping described herein such that each preamble resource occasion (i.e., preamble space) is mapped to a number of PUSCH repetitions multiplexed in N PUSCH occasions and a repetition mapping type. In some cases, the number of PUSCH repetitions and preamble repetitions may be a function of RSRP thresholds based on a received SSB signaled in remaining minimum system information (RMSI). In such cases, the NE may configure a mapping between the preambles in the preamble resource occasion to PUSCH repetitions and/or a preamble repetition mapping type using a corresponding OCC. For example, to transmit two PUSCH repetitions using an OCC, the UE may select preamble #2 according to a comparison of a received RSRP to a configured RSRP threshold. The selected preamble #2 may indicate, to the NE, the number of PUSCH repetitions (e.g., 2) and/or a repetition mapping type (e.g., 2-TD-OCC) based on the configured mapping. By way of another example, to transmit four PUSCH repetitions using an OCC, the UE may select preamble #4, which may indicate to the NE the number of PUSCH repetitions (e.g., 4) and/or a repetition mapping type (e.g., 4-TD-OCC or 2-FD-OCC and 2-TD-OCC) based on the configured mapping.

In some examples, the NE may configure the mapping such that each preamble space (i.e., the preamble resource occasion) includes a PUSCH occasion where a number of PUSCH repetitions may be orthogonally multiplexed from two or more UEs, and using a configured slot repetition mapping type. For example, preamble #1 may be associated with two repetitions using 2-TD-OCC (e.g., OCC sequence length of 2) and preamble #2 may be associated with four repetitions using 4-TD-OCC (e.g., OCC sequence length of 4), and so forth. By way of example, the preamble resource occasion in the mapping 500 may include a preamble #1, a preamble #2, and a preamble #3. An NE may configure a maximum number of preambles in a preamble resource occasion, and each preamble resource occasion may be associated with a number N PUSCH occasions. In some cases, preamble #1 may be mapped to a PUSCH occasion that is configured to multiplex two UEs using two PUSCH repetitions based on a slot repetition mapping type, such as 2-TD-OCC. Preamble #2 may be mapped to the PUSCH occasion, configured to multiplex two UEs using four PUSCH repetitions using a 4-TD-OCC slot repetition mapping type, and preamble #3 may be mapped to the PUSCH occasion, configured with a 2-FD-OCC and 4-TD-OCC slot repetition mapping type.

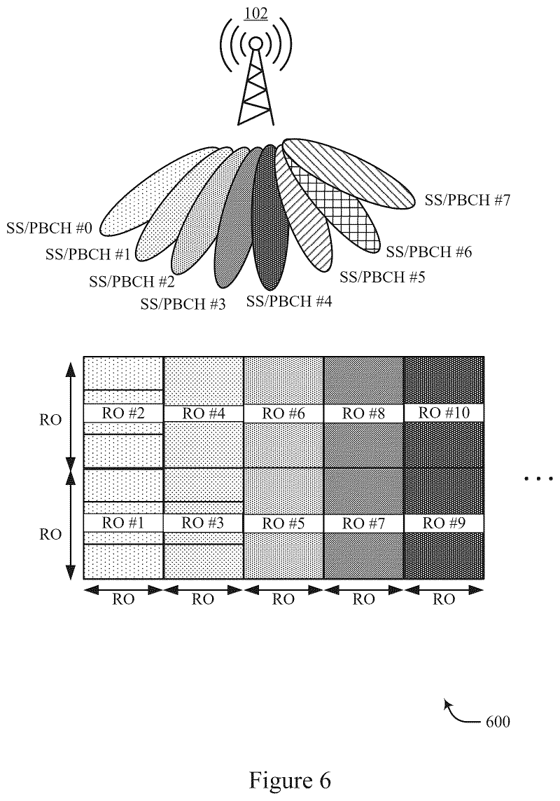

FIG. 6 illustrates an example of a mapping 600 in accordance with aspects of the present disclosure. In this example, the mapping 600 may be between SSBs (e.g., synchronization signals (SSs)/physical broadcast channels (PBCHs)), ROs (e.g., for 2-step RACH), and OCC-PUSCH transmissions.

In the example of FIG. 6, each SS/PBCH block may be mapped to two Ros, such that N=½. The number of frequency division multiplexed (FDMed) ROs is equal to 2. In some examples a semi-static configuration in an RMSI may inform a UE about a number of preambles in a preamble resource occasion, which an NE 102 may configure to be the same per RO or set of ROs. Otherwise, the NE 102 may configure a different number of preambles per RO or per set of ROs. Additionally, the NE 102 may configure a mapping between one or more preambles within a preamble resource occasion and an OCC sequence length or an OCC sequence index (e.g., an OCC) as described herein. For example, in the mapping 600, SS/PBCH #0 may be mapped to RO #1 and RO #2, SS/PBCH #1 may be mapped to RO #3 and RO #4, SS/PBCH #2 may be mapped to RO #5 and RO #6, SS/PBCH #3 may be mapped to RO #7 and RO #8, SS/PBCH #4 may be mapped to RO #9 and RO #10, and so forth. In some other implementations, when two SS/PBCH blocks are mapped to one RO (e.g., N=2), the number of FDMed ROs is 2. In such cases, each RO may be mapped to a number of preamble and Msg-A repetitions using an OCC sequence length or an OCC sequence index.

In some implementations, each RO may be mapped to a different number of PUSCH repetitions or different slot repetition mapping types. Additionally, or alternatively, each preamble may be mapped to a number of PUSCH repetitions or slot repetition mapping types. Alternatively, the UE may apply a same OCC for multiple preambles (e.g., two preambles), where the OCC may be used to orthogonally spread Zadoff-Chu sequences for a Msg-A PUSCH. The UE may select an OCC with an OCC sequence length depending on an RSRP threshold, as described herein with reference to FIG. 5. If several OCC sequence indices correspond to a particular OCC sequence length, the UE may randomly select one OCC sequence index. Moreover, since the preamble and OCC sequence length or OCC sequence index may be preconfigured semi-statically, the UE may apply a same OCC for a randomly selected preamble and a Msg-A PUSCH. Alternatively, a Message B (Msg-B) including random access preamble ID may also include a detected OCC ID corresponding to the preamble ID, a Msg-A PUSCH, or both.

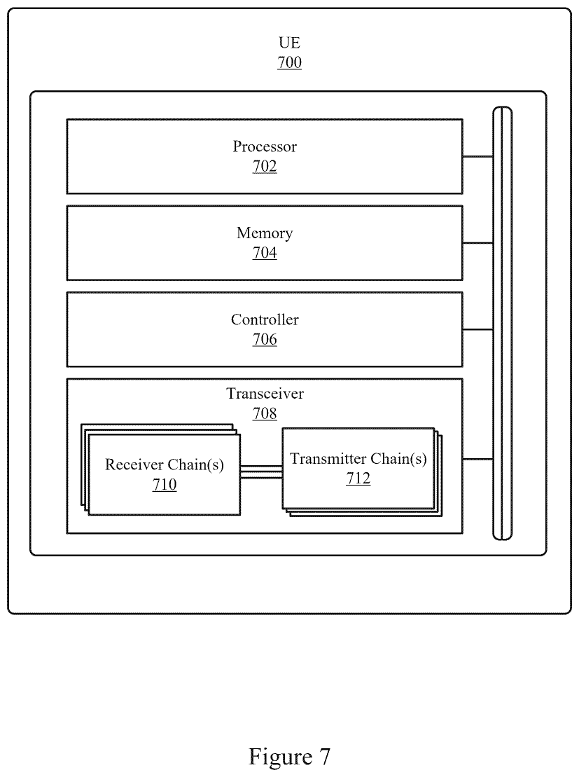

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving configuration information that indicates a mapping of a preamble space of a RACH and one or more corresponding ROs with a set of multiple PUSCH occasions and a set of multiple OCCs; determining, based on the mapping, one or more PUSCH occasions from the set of multiple PUSCH occasions and an OCC from the set of multiple OCCs; and transmitting a set of multiple PUSCH repetitions in the one or more PUSCH occasions, where the set of multiple PUSCH repetitions are multiplexed in a time-frequency resource based on the OCC.

Additionally, the UE 700 may be configured to support any one or combination of determining at least an OCC sequence index or an OCC sequence length corresponding to the OCC; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; or where the configuration information indicates a set of multiple PUSCH repetitions mapped to the preamble space based on an RSRP threshold, and where the at least one processor is further operable to cause the UE to select a preamble from the preamble space based on a compare of an RSRP of a received signal to the RSRP threshold.

Additionally, or alternatively, the UE 700 may support at least one memory (e.g., the memory 704) and at least one processor (e.g., the processor 702) coupled with the at least one memory and configured to cause the UE to receive configuration information that indicates a mapping of a preamble space of a RACH and one or more corresponding ROs with a set of multiple PUSCH occasions and a set of multiple OCCs; determine, based on the mapping, one or more PUSCH occasions from the set of multiple PUSCH occasions and an OCC from the set of multiple OCCs; and transmit a set of multiple PUSCH repetitions in the one or more PUSCH occasions, where the set of multiple PUSCH repetitions are multiplexed in a time-frequency resource based on the OCC.

Additionally, the UE 700 may be configured to support any one or combination of determining at least an OCC sequence index or an OCC sequence length corresponding to the OCC; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; or where the configuration information indicates a set of multiple PUSCH repetitions mapped to the preamble space based on an RSRP threshold, and where the at least one processor is further operable to cause the UE to select a preamble from the preamble space based on a compare of an RSRP of a received signal to the RSRP threshold.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

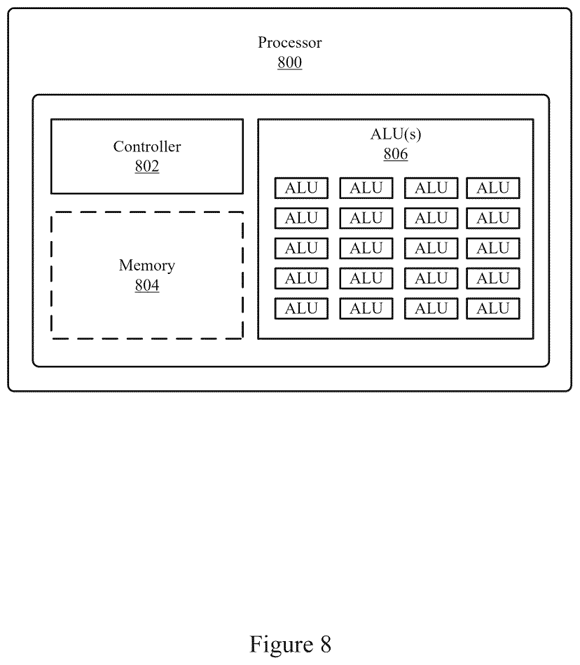

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive configuration information that indicates a mapping of a preamble space of a RACH and one or more corresponding ROs with a set of multiple PUSCH occasions and a set of multiple OCCs; determine, based on the mapping, one or more PUSCH occasions from the set of multiple PUSCH occasions and an OCC from the set of multiple OCCs; and transmit a set of multiple PUSCH repetitions in the one or more PUSCH occasions, where the set of multiple PUSCH repetitions are multiplexed in a time-frequency resource based on the OCC.

Additionally, the processor 800 may be configured to or operable to support any one or combination of determining at least an OCC sequence index or an OCC sequence length corresponding to the OCC; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; or where the configuration information indicates a set of multiple PUSCH repetitions mapped to the preamble space based on an RSRP threshold, and where the at least one processor is further operable to cause the UE to select a preamble from the preamble space based on a compare of an RSRP of a received signal to the RSRP threshold.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit configuration information that indicates a mapping of a preamble space of a RACH and one or more corresponding ROs with a set of multiple PUSCH occasions and a set of multiple OCCs; and receive a set of multiple PUSCH repetitions in one or more PUSCH occasions, where the set of multiple PUSCH repetitions are multiplexed in a time-frequency resource based on an OCC of the set of multiple OCCs.

Additionally, the processor 800 may be configured to or operable to support any one or combination of where the OCC corresponds to an OCC sequence index and an OCC sequence length; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; where the configuration information indicates a set of multiple PUSCH repetitions mapped to the preamble space based on an RSRP threshold.

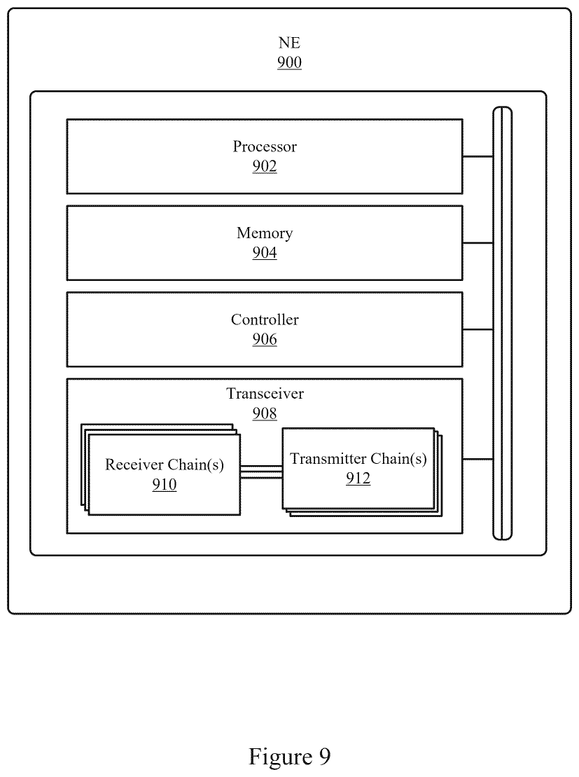

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting configuration information that indicates a mapping of a preamble space of a RACH and one or more corresponding ROs with a set of multiple PUSCH occasions and a set of multiple OCCs; and receiving a set of multiple PUSCH repetitions in one or more PUSCH occasions, where the set of multiple PUSCH repetitions are multiplexed in a time-frequency resource based on an OCC of the set of multiple OCCs.

Additionally, the NE 900 may be configured to or operable to support any one or combination of where the OCC corresponds to an OCC sequence index and an OCC sequence length; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; where the configuration information indicates a set of multiple PUSCH repetitions mapped to the preamble space based on an RSRP threshold.

Additionally, or alternatively, the NE 900 may support at least one memory (e.g., the memory 904) and at least one processor (e.g., the processor 902) coupled with the at least one memory and configured to cause the NE to transmit configuration information that indicates a mapping of a preamble space of a RACH and one or more corresponding ROs with a set of multiple PUSCH occasions and a set of multiple OCCs; and receive a set of multiple PUSCH repetitions in one or more PUSCH occasions, where the set of multiple PUSCH repetitions are multiplexed in a time-frequency resource based on an OCC of the set of multiple OCCs.

Additionally, the NE 900 may be configured to support any one or combination of where the OCC corresponds to an OCC sequence index and an OCC sequence length; where the configuration information indicates a maximum number of preambles in the preamble space; where the preamble space includes one or more preambles associated with respective preamble IDs, and where the respective preamble IDs are mapped to corresponding OCC IDs associated with the set of multiple OCCs; where the set of multiple PUSCH repetitions are multiplexed based on a slot repetition mapping type; where the slot repetition mapping type is a TD-OCC slot repetition mapping type or an FD-OCC slot repetition mapping type, where the TD-OCC slot repetition mapping type is based on inter-slot repetitions and an OCC sequence length and the FD-OCC slot repetition mapping type is based on intra-slot repetitions and an OCC sequence length; where the configuration information indicates a mapping between a set of multiple OCC sequence lengths and the set of multiple PUSCH occasions for a number of PUSCH repetitions; where the configuration information indicates a mapping between the preamble space, a slot repetition mapping type, and a number of the set of multiple PUSCH repetitions multiplexed in a number of the set of multiple PUSCH occasions; where the configuration information indicates a set of multiple PUSCH repetitions mapped to the preamble space based on an RSRP threshold.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

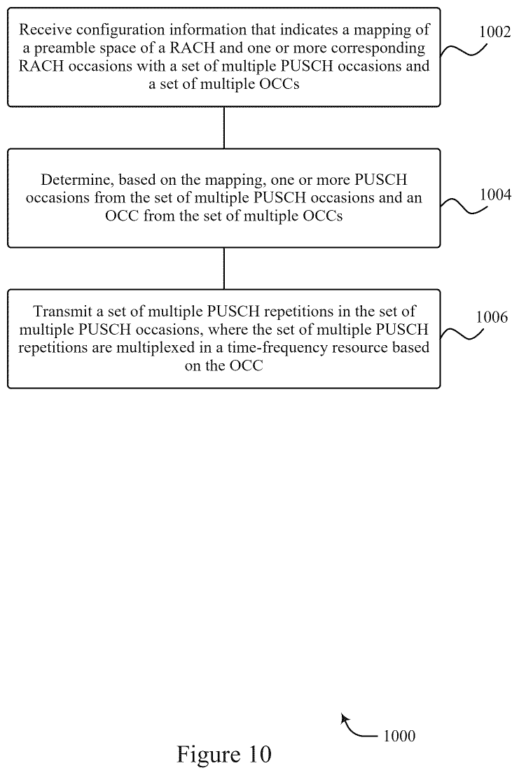

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving configuration information that indicates a mapping of a preamble space of a RACH and one or more corresponding ROs with a set of multiple PUSCH occasions and a set of multiple OCCs. The operations of 1002 may be performed in accordance with examples as described herein. In some implementations, aspects of the operations of 1002 may be performed by a UE as described with reference to FIG. 7.

At 1004, the method may include determining, based on the mapping, one or more PUSCH occasions from the set of multiple PUSCH occasions and an OCC from the set of multiple OCCs. The operations of 1004 may be performed in accordance with examples as described herein. In some implementations, aspects of the operations of 1004 may be performed by a UE as described with reference to FIG. 7.

At 1006, the method may include transmitting a set of multiple PUSCH repetitions in the one or more PUSCH occasions, where the set of multiple PUSCH repetitions are multiplexed in a time-frequency resource based on the OCC. The operations of 1006 may be performed in accordance with examples as described herein. In some implementations, aspects of the operations of 1006 may be performed a UE as described with reference to FIG. 7.

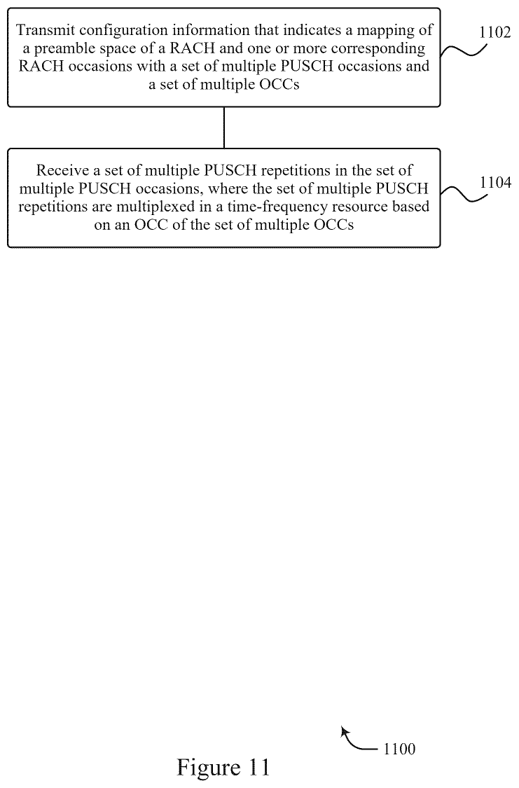

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting configuration information that indicates a mapping of a preamble space of a RACH and one or more corresponding ROs with a set of multiple PUSCH occasions and a set of multiple OCCs. The operations of 1102 may be performed in accordance with examples as described herein. In some implementations, aspects of the operations of 1102 may be performed by an NE as described with reference to FIG. 9.

At 1104, the method may include receiving a set of multiple PUSCH repetitions in one or more PUSCH occasions, where the set of multiple PUSCH repetitions are multiplexed in a time-frequency resource based on an OCC of the set of multiple OCCs. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive configuration information that indicates a mapping of a preamble space of a random access channel (RACH) and one or more corresponding RACH occasions (ROs) with a plurality of physical uplink shared channel (PUSCH) occasions and a plurality of orthogonal cover codes (OCCs);
determine, based at least in part on the mapping, one or more PUSCH occasions from the plurality of PUSCH occasions and an OCC from the plurality of OCCs; and
transmit a plurality of PUSCH repetitions in the one or more PUSCH occasions, wherein the plurality of PUSCH repetitions are multiplexed in a time-frequency resource based at least in part on the OCC.

2. The UE of claim 1, wherein, to determine the OCC, the at least one processor is further operable to cause the UE to determine at least an OCC sequence index or an OCC sequence length corresponding to the OCC.

3. The UE of claim 1, wherein the configuration information indicates a maximum number of preambles in the preamble space.

4. The UE of claim 1, wherein the preamble space comprises one or more preambles associated with respective preamble identifiers (IDs), and wherein the respective preamble IDs are mapped to corresponding OCC IDs associated with the plurality of OCCs.

5. The UE of claim 1, wherein the plurality of PUSCH repetitions are multiplexed based at least in part on a slot repetition mapping type.

6. The UE of claim 5, wherein the slot repetition mapping type is a time domain OCC (TD-OCC) slot repetition mapping type or a frequency domain (FD-OCC) slot repetition mapping type, wherein the TD-OCC slot repetition mapping type is based at least in part on inter-slot repetitions and an OCC sequence length and the FD-OCC slot repetition mapping type is based at least in part on intra-slot repetitions and an OCC sequence length.

7. The UE of claim 1, wherein the configuration information indicates a mapping between a plurality of OCC sequence lengths and the plurality of PUSCH occasions for a number of PUSCH repetitions.

8. The UE of claim 1, wherein the configuration information indicates a mapping between the preamble space, a slot repetition mapping type, and a number of the plurality of PUSCH repetitions multiplexed in a number of the plurality of PUSCH occasions.

9. The UE of claim 1, wherein the configuration information indicates a plurality of PUSCH repetitions mapped to the preamble space based at least in part on a reference signal received power (RSRP) threshold, and wherein the at least one processor is further operable to cause the UE to select a preamble from the preamble space based at least in part on a compare of an RSRP of a received signal to the RSRP threshold.

10. A network equipment (NE) for wireless communication, comprising:
at least one memory; and
at least one processor coupled with the at least one memory and operable to cause the NE to:
transmit configuration information that indicates a mapping of a preamble space of a random access channel (RACH) and one or more corresponding RACH occasions (ROs) with a plurality of physical uplink shared channel (PUSCH) occasions and a plurality of orthogonal cover codes (OCCs); and
receive a plurality of PUSCH repetitions in one or more PUSCH occasions, wherein the plurality of PUSCH repetitions are multiplexed in a time-frequency resource based at least in part on an OCC of the plurality of OCCs.

11. The NE of claim 10, wherein the OCC corresponds to an OCC sequence index and an OCC sequence length.

12. The NE of claim 10, wherein the configuration information indicates a maximum number of preambles in the preamble space.

13. The NE of claim 10, wherein the preamble space comprises one or more preambles associated with respective preamble identifiers (IDs), and wherein the respective preamble IDs are mapped to corresponding OCC IDs associated with the plurality of OCCs.

14. The NE of claim 10, wherein the plurality of PUSCH repetitions are multiplexed based at least in part on a slot repetition mapping type.

15. The NE of claim 14, wherein the slot repetition mapping type is a time domain OCC (TD-OCC) slot repetition mapping type or a frequency domain (FD-OCC) slot repetition mapping type, wherein the TD-OCC slot repetition mapping type is based at least in part on inter-slot repetitions and an OCC sequence length and the FD-OCC slot repetition mapping type is based at least in part on intra-slot repetitions and an OCC sequence length.

16. The NE of claim 10, wherein the configuration information indicates a mapping between a plurality of OCC sequence lengths and the plurality of PUSCH occasions for a number of PUSCH repetitions.

17. The NE of claim 10, wherein the configuration information indicates a mapping between the preamble space, a slot repetition mapping type, and a number of the plurality of PUSCH repetitions multiplexed in a number of the plurality of PUSCH occasions.

18. The NE of claim 10, wherein the configuration information indicates a plurality of PUSCH repetitions mapped to the preamble space based at least in part on a reference signal received power (RSRP) threshold.

19. A method performed by a user equipment (UE), the method comprising:
receiving configuration information that indicates a mapping of a preamble space of a random access channel (RACH) and one or more corresponding RACH occasions (ROs) with a plurality of physical uplink shared channel (PUSCH) occasions and a plurality of orthogonal cover codes (OCCs);
determining, based at least in part on the mapping, one or more PUSCH occasions from the plurality of PUSCH occasions and an OCC from the plurality of OCCs; and
transmitting a plurality of PUSCH repetitions in the one or more PUSCH occasions, wherein the plurality of PUSCH repetitions are multiplexed in a time-frequency resource based at least in part on the OCC.

20. A method performed by a network equipment (NE), the method comprising:
transmitting configuration information that indicates a mapping of a preamble space of a random access channel (RACH) and one or more corresponding RACH occasions (ROs) with a plurality of physical uplink shared channel (PUSCH) occasions and a plurality of orthogonal cover codes (OCCs); and
receiving a plurality of PUSCH repetitions in one or more PUSCH occasions, wherein the plurality of PUSCH repetitions are multiplexed in a time-frequency resource based at least in part on an OCC of the plurality of OCCs.
